(19) United States
(12) Patent Application Publication
(10) Pub. No.: US 2025/0232156 A1
(43) Pub. Date: Jul. 17, 2025

(54) TECHNIQUES FOR INTER-OPERATION OF A TWO-SIDED ARTIFICIAL INTELLIGENCE MODEL USING AN ADAPTER

(71) Applicant: Lenovo (United States) Inc., Morrisville, NC (US)

(72) Inventors: Mahdi Barzegar Khalilsarai, Berlin (DE); Vahid Pourahmadi, München (DE)

(21) Appl. No.: 19/169,940

(22) Filed: Apr. 3, 2025

(51) Int. Cl. G06N 3/0455

(52) U.S. Cl. CPC G06N 3/0455

(57) ABSTRACT

Various aspects of the present disclosure relate to techniques for inter-operation of a two-sided artificial intelligence model using an adapter. An apparatus is configured to receive an indication of an anomaly in data output by the encoder, the encoder associated with a decoder at a receiver node, receive a training data set for training the adapter network in response to the indication of the anomaly, train the adapter network using the training data set, process the data output from the encoder using the adapter network prior to transmitting the data to the decoder, and transmit the processed data to the decoder.

### TECHNICAL FIELD

The present disclosure relates to wireless communications, and more specifically to techniques for inter-operation of a two-sided artificial intelligence (AI) model using an adapter.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A transmitter node for wireless communication is described. The transmitter node may be configured to, capable of, or operable to receive an indication of an anomaly in data output by an encoder, the encoder associated with a decoder at a receiver node; receive a training data set for training the adapter network in response to the indication of the anomaly, the adapter network comprising a machine learning (ML) model that is configured to correct anomalies in the data output by the encoder; train the adapter network using the training data set; process the data output from the encoder using the adapter network prior to transmitting the data to the decoder; and transmit the processed data to the decoder.

A processor for wireless communication is described. The processor may be configured to, capable of, or operable to receive an indication of an anomaly in data output by an encoder, the encoder associated with a decoder at a receiver node; receive a training data set for training the adapter network in response to the indication of the anomaly, the adapter network comprising an ML model that is configured to correct anomalies in the data output by the encoder; train the adapter network using the training data set; process the data output from the encoder using the adapter network prior to transmitting the data to the decoder; and transmit the processed data to the decoder.

A method for wireless communication performed by a transmitter node is described. The method may be configured to, capable of, or operable to receive an indication of an anomaly in data output by an encoder, the encoder associated with a decoder at a receiver node; receive a training data set for training the adapter network in response to the indication of the anomaly, the adapter network comprising an ML model that is configured to correct anomalies in the data output by the encoder; train the adapter network using the training data set; process the data output from the encoder using the adapter network prior to transmitting the data to the decoder; and transmit the processed data to the decoder.

A receiver node for wireless communication is described. The receiver node may be configured to, capable of, or operable to receive data output by an encoder of a transmitter node, the encoder associated with a decoder; determine an indication of an anomaly in the data output by the encoder; receive a training data set for training the adapter network in response to the indication of the anomaly, the adapter network comprising an ML model that is configured to correct anomalies in the data output by the encoder; train the adapter network using the training data set; process the data output by the encoder using the adapter network; and decode, by the decoder, output from the adapter network.

A processor for wireless communication is described. The processor may be configured to, capable of, or operable to receive data output by an encoder of a transmitter node, the encoder associated with a decoder; determine an indication of an anomaly in the data output by the encoder; receive a training data set for training the adapter network in response to the indication of the anomaly, the adapter network comprising an ML model that is configured to correct anomalies in the data output by the encoder; train the adapter network using the training data set; process the data output by the encoder using the adapter network; and decode, by the decoder, output from the adapter network.

A method for wireless communication performed by a receiver node is described. The method may be configured to, capable of, or operable to receive data output by an encoder of a transmitter node, the encoder associated with a decoder; determine an indication of an anomaly in the data output by the encoder; receive a training data set for training the adapter network in response to the indication of the anomaly, the adapter network comprising an ML model that is configured to correct anomalies in the data output by the encoder; train the adapter network using the training data set; process the data output by the encoder using the adapter network; and decode, by the decoder, output from the adapter network.

### BRIEF DESCRIPTION OF THE DRAWINGS

FIG. 1 illustrates an example of a wireless communications system, in accordance with aspects of the present disclosure.

FIG. 2A illustrates an example of an adapter placed at the encoder output, in accordance with aspects of the present disclosure.

FIG. 2B illustrates an example of an adapter placed at the decoder input, in accordance with aspects of the present disclosure.

FIG. 3 illustrates an example of a UE, in accordance with aspects of the present disclosure.

FIG. 4 illustrates an example of a processor, in accordance with aspects of the present disclosure.

FIG. 5 illustrates an example of an NE, in accordance with aspects of the present disclosure.

FIG. 6 illustrates a flowchart of a method performed by an NE, in accordance with aspects of the present disclosure.

FIG. 7 illustrates a flowchart of a method performed by a UE, in accordance with aspects of the present disclosure.

### DETAILED DESCRIPTION

Generally, the present disclosure describes systems, methods, and apparatuses for techniques for inter-operation of a two-sided AI model using an adapter. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In wireless networks, such as 5G networks, AI and/or ML models may be used to process various types of data. For instance, AI/ML models may be used for channel state information (CSI) feedback enhancement, beam management, positioning, or the like. Broadly, there are two types of AI/ML models, namely the one-sided and the two-sided models. In one-sided models, the model includes one part deployed at one node, e.g., either at a gNB or at a UE. In two-sided models, the models include two parts, each deployed in a separate node, e.g., at both the gNB and at the UE. One example of a two-sided model is an autoencoder including an encoder and a decoder, each deployed at either the gNB or the UE. For example, in CSI compression the encoder is deployed at the UE and compresses the CSI into a codeword, while the decoder, located at the gNB, maps the compressed codeword to an estimate of the CSI.

Two-sided models may offer better performance compared to one-sided models, at the expense of higher signaling overhead. This is due to training the model jointly by two network nodes or at one of the nodes. In the first case, training information (datasets and gradients) are exchanged between the nodes and in the second case trained parameters of at least one part of the models are transferred from one node to the other. Since both impose large signaling overhead, it would be beneficial to have two-sided models in which each part of the model is trained separately over generally different datasets. However, this approach may exclude extra components and may result in poor performance because the latent spaces of the two parts of the model (the output space of the first part and the input space of the second part) are mismatched.

As used herein, latent space may refer to a learned, compressed representation of network states, traffic patterns, or user behaviors. This concept is widely used in AI-driven network optimization, anomaly detection, and predictive maintenance. By encoding high-dimensional network data into a lower-dimensional space, ML models can extract meaningful features that help improve efficiency and performance.

The solutions herein describe apparatuses, systems, and methods that allow the UE to align the latent space of its part of the AI/ML model with that of the part of the AI/ML model deployed at the gNB using an “adapter”. As used herein, the adapter is a relatively small AI/ML model whose task is to map the codewords in the latent space of the UE model part to their proper counterparts in the latent space of the gNB model part. The adapter can be trained using a much smaller dataset than what is necessary to train the entire AI/ML model.

The advantage of this approach is two-fold: first, separately trained parts of a two-sided model become inter-operable with a small overhead. This is important not only because it reduces overhead, but also because it enables model parts used by different vendors to operate together. Second, it makes operations with two-sided models flexible depending on model updates at the network side or switching from one cell to another.

The solutions described herein improve various characteristics of the NE and/or the UE such as improved initial access procedures, improved signal reliability, improved resource utilization, improved energy efficiency, and improved latency. In this manner, signaling, battery life, and operational efficiencies in NE and/or UE devices can be enhanced.

Aspects of the present disclosure are described in the context of a wireless communications system. Note that one or more aspects from different solutions may be combined.

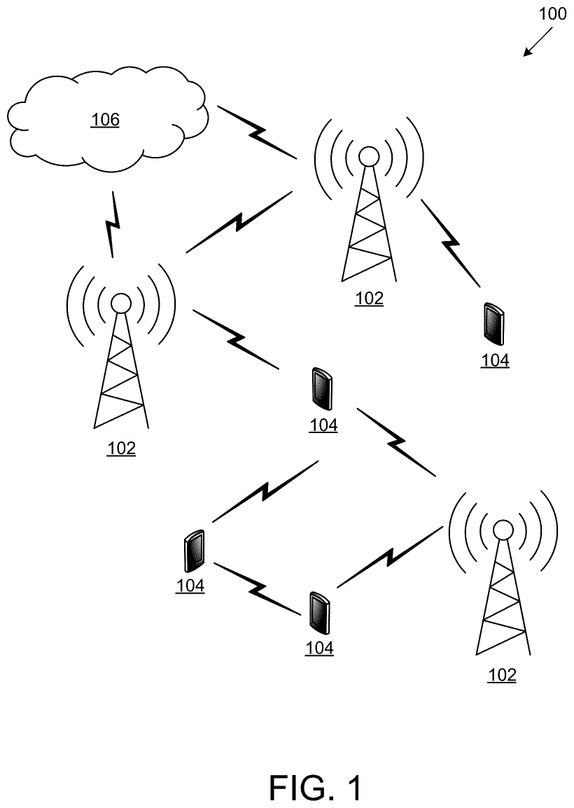

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHZ), FR3 (7.125 GHz-24.25 GHZ), FR4 (52.6 GHZ-114.25 GHz), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In general, an AI/ML framework for wireless communications includes various modules, functions, or the like that may be interconnected or in communication. For instance, an AI/ML functional framework may include a Data Collection module that is responsible for gathering various types of data essential for the AI/ML system. It provides training data for model development, monitoring data for management purposes, and inference data for real-time decision-making.

The framework may include a Model Training module that focuses on training, validating, and testing AI/ML models. This process generates performance metrics that can be used for further evaluation. Additionally, this module plays a crucial role in data preparation, including cleaning, formatting, transforming, and preprocessing the training data provided by the Data Collection module when required.

The framework may include a Management module that oversees the operation and monitoring of AI/ML models. It ensures the proper functioning of inference operations based on monitoring data and inference output. This module produces management instructions, which may include actions such as selecting, activating or deactivating models, switching AI/ML functionalities, or even reverting to non-AI/ML modes when necessary.

The framework may include an Inference module that processes inference data by applying AI/ML models or functionalities to generate output. It is also responsible for data preparation tasks, including cleaning, formatting, and transformation, based on the inference data received from the Data Collection module. The inference output is then utilized by the Management module to monitor the performance of AI/ML models or functionalities.

The framework may include a Model Storage module that is responsible for storing trained or updated models received from the Model Training module. It also facilitates the transfer of models to the Inference module upon request from the Management module.

In one example, to improve the efficiency of network operations, life cycle management (LCM) of AI/ML models may be utilized. In one example, functionality-based LCM may be used where AI/ML models, their activation, deactivation, fallback and switching are decided/managed according to their functional role. A model is categorized based on its function, rather than specific version or ID. A UE may have one or several models for a specific functionality. For AI/ML functionality identification and functionality-based LCM of UE-side models and/or UE-part of two-sided models, functionality refers to an AI/ML-enabled Feature/FG enabled by configuration(s), where configuration(s) is (are) supported based on conditions indicated by UE capability.

In one example, Model-ID-based LCM may identify models at the network, and the network/UE may activate/deactivate/select/switch individual AI/ML models via a model ID. For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

In one example, AI/ML models may be used to process various types of data. For instance, AI/ML models may be used for CSI feedback enhancement, beam management, positioning, or the like. For instance, CSI feedback overhead is large, especially with a large number of transmit antenna ports at the gNB. The goal is to use AI/ML models to efficiently compress and reconstruct CSI, reducing feedback overhead while maintaining high accuracy. Further, beam management may be time consuming and incur a large overhead due to the large number of beams and UE mobility. The goal is to use AI/ML models to help with beam selection, switching and prediction. Additionally, in positioning, the goal is to use AI/ML models for accurate positioning in complex environments even with no line-of-sight (LoS).

There are generally two types of AI/ML models for CSI feedback—the one-sided model, in which the model is placed entirely at one node (e.g. either the UE or the base station) and the two-sided model, where one part of the model, namely the encoder, is implemented at a first node (e.g., the UE) and the other part, namely the decoder, is implemented at a second node (e.g., the gNB). In comparison to one-sided models, two-sided models require more standardization effort since they involve more signaling between the UE and the network to enable the cooperation of the two separate sides of the model.

The subject matter herein describes solutions for two-sided models. Although the concept of a two-sided model is applicable to various use cases (CSI compression, beam management, positioning, or the like), for the sake of convenience, two-sided models are discussed in the context of CSI compression. However, the solutions described are applicable to any two-sided model.

In CSI compression with a two-sided model, the UE first estimates CSI from downlink reference signals (e.g., CSI-RS) and then uses an encoder to compress either explicit or implicit CSI. Explicit CSI includes raw estimates of the channel coefficients obtained at the UE. Implicit CSI includes a computed precoding matrix based on the estimated channel.

The input, regardless of it being implicit or explicit CSI, is denoted by x. In a two-sided model, an encoder E: [symbol] > [symbol] maps the input x to the compressed CSI z=E(x), and a decoder D: [symbol] > [symbol] , which maps the compressed CSI to the reconstruction \hat{x}=D(z). E and D are implemented as neural networks (NNs) including several layers each and parameterized by weights and biases. E can therefore be denoted by E_{θ} and D by D_{ϕ}, where θ and ϕ denote the encoder and decoder parameters, respectively.

These parameters are optimized in the training process using a dataset of input samples D_{X}={xᵢ,i =1, . . . , N}. Training is equivalent to minimizing the average reconstruction error over the dataset. To formulate this, let [symbol] : [symbol] × [symbol] → [symbol] ₊ denote a loss function that measures the error between input and reconstructed CSI. Examples of a loss function are the [symbol] ₂ loss [symbol] (x, \hat{x})=∥x−\hat{x}∥₂² and the [symbol] ₁ loss [symbol] (x, \hat{x})=∥x−\hat{x}∥₁. The average cost function over the whole dataset is defined as L(θ, ϕ)=Σᵢ₌₁^{N} [symbol] (x, D_{ϕ}(E_{θ}(x))).

Optimal encoder and decoder parameters are obtained by minimizing the cost function as

$$( {θ}^{★} , {ϕ}^{★} ) = arg {min}_{θ , ϕ} L ( θ , ϕ ) .$$

This minimization can be performed via gradient descent and efficiently implemented using backpropagation. After training the optimized parameters are used for inference, in compressing CSI as z=E_{θ*}(x) at the UE and de-compressing it as \hat{x}=D_{ϕ*}(z) at the base station.

For the training of two-sided models, three methods may be used depending on the cooperation required between the gNB and UE. In one example, the encoder and decoder may be jointly trained at one side, e.g. the gNB. Then the encoder part of the model is transferred to the UE to be used. Although in principle training can be performed at either the UE or the gNB side, it is more reasonable to perform it at the gNB because the gNB can keep one trained decoder and transfer encoders to any incoming UE, whereas receiving a different decoder from different UEs is not reasonable.

In one example, the encoder and decoder are jointly trained at the UE and the gNB, respectively, in a shared loop. This is done by exchanging forward activation and backward propagation gradient values between the UE and the gNB in a gradient descent optimization process.

In one example, the encoder and decoder are trained separately on each node. This training can start at either the UE or the gNB. If it starts at the UE, the UE trains its encoder and then shares a dataset of its encoder output and target CSI with the network. The network then uses this dataset to train its model. Another option is to reverse this, where the network first trains its decoder and then shares a dataset of decoder input and target CSIs with the UE so that the UE trains its own encoder.

As depicted herein, in the foregoing methods, the training process might not occur at the UE and gNB itself and may instead occur at a node communicatively coupled to the UE-side and NW-side. The trained encoder model is then transferred/delivered to the UEs and the trained decoder part resides in the gNBs.

In one example, jointly training both the encoder and decoder at a single node requires disclosure of proprietary information by the UE vendor to the network side, since the UE should be able to implement the encoder trained by the network. This is challenging since different vendors are reluctant to share their models' information. In jointly training the encoder and decoder on both nodes, model information is not exchanged, but sharing forward activation and backward propagation data incurs large overhead on the network. Further, separately training the encoder and decoder does not require the exchange of models and their parameters and does not require joint training.

In certain scenarios, the UE and gNB may have their respective trained encoder and decoder already trained, but a change or update to the models may be needed. For instance, the gNB may have a trained decoder and does not wish to re-train it based on the dataset received from a UE, or the UE may have a trained encoder and does not wish to re-train it based on the dataset received from the gNB. Or, after the completion of the training phase, the decoder/encoder model may need to be updated. For example, the gNB may get new training samples collected from a new UE and accordingly, the decoder needs an update to capture the statistics of the new UE's CSI as well. Corresponding to this updated decoder, the encoder at the UE needs to be updated. In another example, the UE may have a previously obtained version of the encoder, but it notices a mismatch between the encoder and the decoder of the gNB. This mismatch could happen for example after the UE moves to a new cell or after a change in the statistics of the input data.

To address these potential issues, the gNB and UE can update their models by exchanging model parameters, forwarding activation and backward propagation data, or using large datasets to obtain models that match the other node. Each of these methods incur overhead and may not be necessary once the models are initially trained and just need an update.

Alternatively, several models can be trained for different cases and the appropriate model may be activated based on the current condition. For example, to train different encoder and decoder pairs for each cell and after each handover the UE switches to the corresponding encoder model. However, an issue with these various schemes is the complexity, where several pairs need to be trained, and the UE needs to have access to (or store) different models so it can switch to them if needed. The inaccuracy of the switching mechanism may also result in some performance degradations and errors.

Thus, the subject matter herein proposes a capability to adapt previously trained sides of a two-sided AI/ML model with appropriate signaling and the exchanging of a small dataset. In one example, a small “adapter” neural network is included, either at the output of the encoder or the input of the decoder, to align the latent spaces (e.g., the input/output space of the decoder/encoder) of the two sides. Since each side is assumed to be trained, they are already capable of compressing/decompressing large-dimensional inputs. The adapter network only tries to match the optimized latent spaces of the two sides. This method has the additional advantage that, since the adapter is a small network, it can be trained on the device and does not need to be trained on a remote device, e.g., on a cloud device.

In one example, consider a two-sided CSI compression model including an encoder E: [symbol] → [symbol] trained on a dataset [symbol] _{A}, and a decoder D: [symbol] ′→ [symbol] trained on a dataset [symbol] _{B}. In one example, E and D are placed on different nodes, are trained separately, and the datasets [symbol] _{A} and [symbol] _{B} are not shared. Typically, E is located at the UE to encode CSI and D is located at the network to decode it. In is assumed that the true and reconstructed CSI space is the same and is denoted by [symbol] . This can represent either the implicit CSI, in the form of the precoding matrix or the explicit CSI in the form of channel coefficients over antenna ports and frequency subcarriers/sub-bands. [symbol] represents the latent space of the encoder E and [symbol] ′ the latent space of the decoder D. [symbol] and [symbol] ′ may have different dimensions. Since E and D are trained separately and on different datasets, the distribution of latent codes z=E(x) is likely different from the codes on which D was trained or expects to decode correctly.

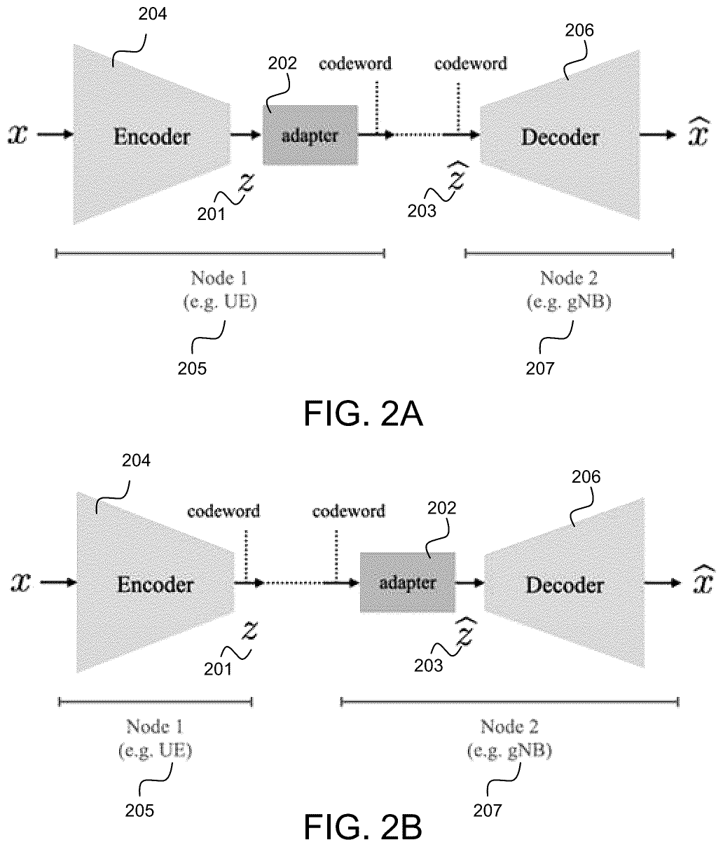

FIG. 2A illustrates an example of an adapter placed at the encoder output, in accordance with aspects of the present disclosure. FIG. 2B illustrates an example of an adapter placed at the decoder input, in accordance with aspects of the present disclosure. In one example, an adapter network 202 F: [symbol] → [symbol] ′ that maps the latent codes in [symbol] 201 to appropriate counterparts in [symbol] ′ 203 is inserted at the output of the encoder 204 or at the input of the decoder 206. In one example, the adapter network 202, F, is a neural network with parameters Θ_{F}. With the inclusion of the adapter network 202, the chain of encoding and decoding takes the form x→z=E(x)=→z′=F(z)→\hat{x}=E(z′).

In one example, to train an adapter network 202 placed at the decoder node 207, the decoder node 207 receives a small dataset D_{C} from the encoder node 203, where D_{C}={(xᵢ, zᵢ), i=1, . . . , N_{C}} where zᵢ=E(xᵢ) and N_{C} is the number of samples. In other words, D_{C} is a set of input-output examples from the encoder 204. The goal is to minimize the error between xᵢ and \hat{x}ᵢ as a function of the parameters of F. So let [symbol] (xᵢ, \hat{x}ᵢ ) be a per-sample reconstruction loss and define a cost function L_{F}(Θ_{F})=Σ₍ₓ_{ᵢ}_{, z}_{ᵢ}_{)∈D}_{_{C}} [symbol] (xᵢ, \hat{x}ᵢ)=Σ₍ₓ_{ᵢ}_{, z}_{ᵢ}_{)∈D}_{_{C}} [symbol] (xᵢ, D(F(zᵢ))). In some examples, the cost is not a function of the encoder and decoder parameters, because those parameters are assumed to be fixed after each side is trained separately. The cost may be a function of adapter parameters Θ_{F}.

In one example, to train an adapter placed at the encoder node 205, the encoder node 205 receives a small dataset Dc from the decoder node 207 where D_{C}={(zᵢ, \hat{x}ᵢ), i=1, . . . , N_{C}} where \hat{x}ᵢ=D(zᵢ), i.e D_{C} is a set of input-output examples from the decoder 206. The situation is different in this case because, although we have reconstructed samples \hat{x}ᵢ, we cannot really find the corresponding input xᵢ because an inversion of the nested function E (F(·)) is not possible. To solve this problem, we treat \hat{x}ᵢ as an input (not reconstructed) CSI and train F(·) such that E(F(\hat{x}ᵢ)) is close to the corresponding latent zᵢ. In this case the cost function is defined as the sum of losses defined over the latent variables instead of input and reconstructed variables, i.e. Lp (Θ_{F})=Σ_{(z}_{ᵢ}_{, z}_{ᵢ}_{)∈D}_{_{C}} [symbol] (zᵢ, D(F(zᵢ))).

In one example, training the bridge network is done via gradient descent or its variants, as Θ_{F}^{(t+1)}←Θ_{F}^{(t)}−η∇_{θ}_{_{F}}L_{F}(Θ_{F}), where n>0 is the gradient step and ∇_{θ}_{_{F}}L_{F}(Θ_{F}) is the gradient of the cost function that can be efficiently computed via back propagation. The initial value of the parameters Θ_{F}⁽⁰⁾ can be chosen randomly or set to zero.

In one example, after training the adapter network 202, the adapter network 202 is used with the optimized parameters Θ*_{F} to perform inference. If the adapter network 202 is placed at the encoder node 205, the input CSI is compressed as z=F(E(x)) and if it is placed at the decoder node 207, the compressed CSI z is decoded as D(F(z)).

In one example, placing the adapter network 202 at the encoder node 205 or decoder node 207 has benefits and disadvantages. Placing the adapter network 202 at the decoder node 207 may yield better results due to the more principled definition of the cost function which can facilitate training. Also, the network has more computational resources to train an adapter network 202, possibly with more parameters and hence higher accuracy. However, since the decoder 206 is located at the network node, it requires the UE to send the dataset [symbol] _{C} to the network, which consumes the UE's energy and uplink channel resources. Placing the adapter network 202 at the encoder node 205 has the advantage that the UE only collects or downloads the dataset [symbol] _{C} from the network, although further training of an adapter network 202 incurs higher computational burden on the UE and may not be energy-efficient.

With either of the options, in one example, the system gains two advantages: (1) instead of exchanging large encoder/decoder models and training datasets between the nodes 205, 207, a small dataset is exchanged; and (2) the encoder 204 and decoder 206 models can be optimized once and used in different scenarios (different cells, channel conditions, or the like) for the purpose of AI-based compression by inserting a small adapter network 202, trained with a small dataset.

In one example, the adapter network 202 includes the initial part of the decoder 206 (e.g., the first few layers) or the final part of the encoder 204 (e.g., the last few layers). These layers are first trained during the separate training of the encoder 204 and the decoder 206. Then, to serve as an adapter network 202, they are fine-tuned based on the small dataset [symbol] _{C} so that they can match the desired latent distribution. At the same time, the rest of the parameters are kept fixed. In terms of optimization via gradient descent, the initial point of the parameters corresponding to the adapter layers is given by the optimized values of the previous round of training the encoder 204 and decoder 206 instead of initializing the values randomly or to zero.

In one example, new CSI and latent code pairs (or latent code and reconstructed CSI pairs) may be exchanged between the nodes 205, 207 so that the node that deploys the adapter network 202 can update its parameters. In one example, this may be applicable in mobility scenarios with fast varying channels, so that the mismatch between latent codes in the encoder output and decoder input remains small.

In one example, the reconstruction quality feedback may be captured and used to adjust the adapter network 202. For instance, the gNB can measure how good the reconstructed CSI is (e.g., compared with actual measured CSI or see the resulting link adaptation performance). The gNB can also feedback a continuous metric or a simple “pass/fail” bit to help the UE adjust the adapter network 202. This can be done, for example, via the L1/L2 procedures or an extension of it.

According to one example, a first node 207 (e.g., a gNB) requests a second node 205 (e.g., a UE) to provide information based on which the first node 207 is aware of the AI/ML functionalities supported by the second node 205 for the first node 207. The second node 205 then indicates in the provided information its model adaptation capability, by which the first node 207 becomes aware that the second node 205 can implement an adapter network 202 to compensate for a potential mismatch between the latent spaces of the encoder 204 and the decoder 206.

In such an example, for example, the gNB requests the supported functionalities from the UE as a UE capability report. After receiving the UECapabilityEnquiry radio resource control (RRC) message containing the AI/ML functionality request, the UE reports the AI/ML functionalities that it supports in general via the UECapabilityInformation RRC message. The model adaptation capability may be included in the UJECapabilityInformation by an extension of this message. Alternatively, the request for this functionality can be sent using a medium access control (MAC) control element (CE) or using downlink control information (DCI). The response containing information on the support of model adaptation capability can be sent via new RRC signaling or new MAC CE.

In one example, a first node 207 (e.g., the gNB) triggers training of an adapter network 202 in a second node 205 (e.g., the UE). In one implementation of the example, the network may trigger the UE to train its adapter network 202. This can happen, for example, when the network detects that the UE's compressed CSI does not match the expected latent space code by its decoder. This occurs, for instance, when there is a change in the channel statistics, or when the network detects an anomaly in the received latent space code. In this case, instead of triggering the UE to re-train its encoder 204 or to send parameters of a new encoder, the network can simply trigger training of an adapter network 202. This trigger can be indicated to the UE, for example, using RRC or MAC CE. In another implementation, the UE requests the training of the adapter network 202.

In one example, a first node 207 (e.g., the gNB) sends an adapter training dataset to a second node 205 (e.g., the UE). In one implementation, the gNB sends a dataset including latent space code and reconstructed CSI pairs to the UE with which the UE can train its adapter network 202. In another implementation, the UE sends a training dataset of CSI and latent space code pairs to the gNB, so that the gNB can train an adapter network 202 if the adapter network 202 is deployed at the gNB or a cloud on the network side.

In one example, a first node 207 (e.g., the gNB) triggers a second node 205 (e.g., the UE) to activate the adapter network 202. In one implementation, the gNB triggers the UE to activate its adapter network 202 for inference. In another implementation, the UE requests the network to activate its adapter network 202. The triggering/request can be performed on demand when a mismatch between the latent space codes on the two sides of the model is detected at either the first or the second node. The triggering of the adaptation network 202 may follow from the second node 207 (e.g., the UE) reporting to the first node 205 (e.g., the gNB) that it has detected a mismatch between the latent spaces of the two sides of the AI/ML model.

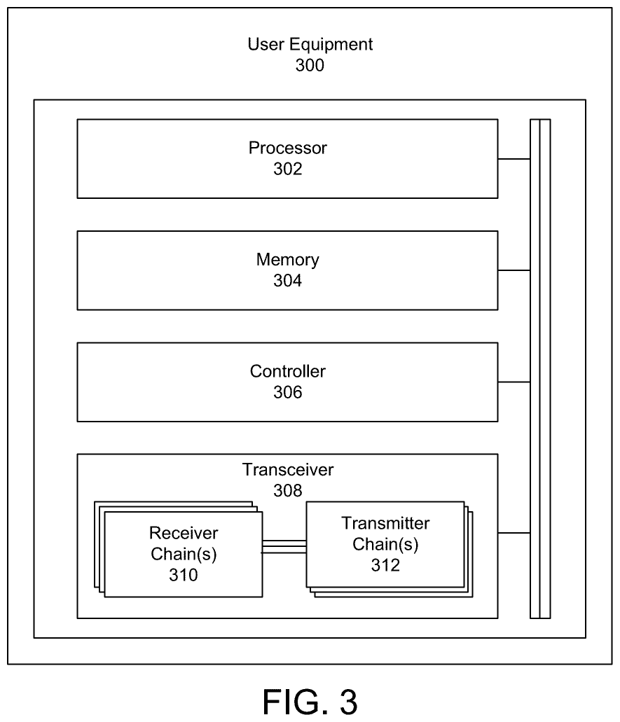

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the UE functions described herein (e.g., executing, by the processor 302, instructions stored in the memory 304). Accordingly, the processor 302 may support wireless communication at the UE 300 in accordance with examples as disclosed herein.

In one example, the UE 300 is configured as a transmitter node that is configured with an encoder and an adapter network. In one example, the transmitter node is configured to receive an indication of an anomaly in data output by the encoder, the encoder associated with a decoder at a receiver node; receive a training data set for training the adapter network in response to the indication of the anomaly, the adapter network comprising an ML model that is configured to correct anomalies in the data output by the encoder; train the adapter network using the training data set; process the data output from the encoder using the adapter network prior to transmitting the data to the decoder; and transmit the processed data to the decoder.

In one example, the transmitter node is configured to transmit capability information to the receiver node, the capability information comprising an indication of the adapter network. In one example, the capability information is included in a capability report transmitted in an RRC message.

In one example, the transmitter node is configured to activate the adapter network in response to receiving an indication to trigger activation of the adapter network based on the anomaly in the data output by the encoder. In one example, the indication to trigger activation of the adapter network is received in an RRC message or a MAC CE message.

In one example, the anomaly in the data output from the encoder comprises a mismatch between the data output by the encoder and an expected latent space code at the decoder. In one example, the transmitter node is configured to transmit a request for the training data set for the adapter network.

In one example, the training data set comprises a data set comprising latent space codes and channel state information pairs. In one example, the transmitter node is configured to request information for one or more features of the training data set. In one example, the transmitter node is configured to transmit a training data set comprising channel state information and latent space codes pairs to an adapter network at the receiver node.

In one example, the transmitter node is configured to transmit a request to activate the adapter network. In one example, the request to activate the adapter network is transmitted in response to detecting the anomaly in the data output by the encoder at the transmitter node. In one example, the ML model comprises a neural network.

In one example, the UE 300 is configured as a receiver node that includes a decoder and an adapter network. In one example, the receiver node is configured to receive data output by an encoder of a transmitter node, the encoder associated with the decoder; determine an indication of an anomaly in the data output by the encoder; receive a training data set for training the adapter network in response to the indication of the anomaly, the adapter network comprising an ML model that is configured to correct anomalies in the data output by the encoder; train the adapter network using the training data set; process the data output by the encoder using the adapter network; and decode, by the decoder, output from the adapter network.

In one example, the receiver node is configured to transmit capability information to the transmitter node, the capability information comprising an indication of the adapter network. In one example, the receiver node is configured to activate the adapter network in response to receiving an indication to trigger activation of the adapter network based on the anomaly in the data output by the encoder.

In one example, the anomaly in the data output by the encoder comprises a mismatch between the data output by the encoder and an expected latent space code at the decoder. In one example, the receiver node is configured to transmit a request for the training data set for the adapter network.

The controller 306 may manage input and output signals for the UE 300. The controller 306 may also manage peripherals not integrated into the UE 300. In some implementations, the controller 306 may utilize an operating system (OS) such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding/processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

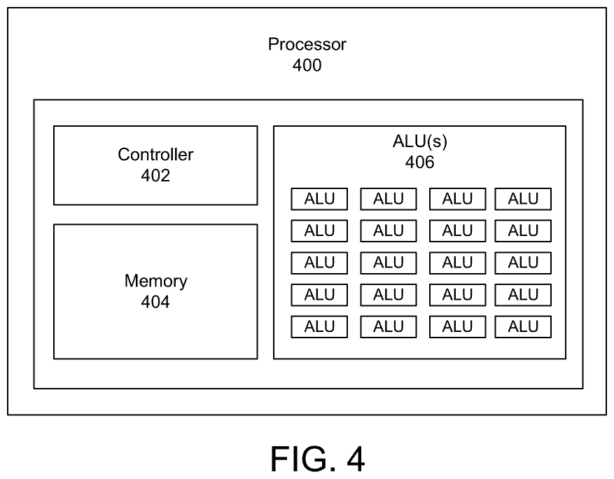

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

In various examples, the processor 400 may support wireless communication of a UE, in accordance with examples as disclosed herein. In other examples, the processor 400 may support wireless communication of a RAN entity, in accordance with examples as disclosed herein.

In one example, the processor 400 is configured as part of a transmitter node that includes an encoder and an adapter network. In one example, the processor 400 is configured to receive an indication of an anomaly in data output by the encoder, the encoder associated with a decoder at a receiver node; receive a training data set for training the adapter network in response to the indication of the anomaly, the adapter network comprising an ML model that is configured to correct anomalies in the data output by the encoder; train the adapter network using the training data set; process the data output from the encoder using the adapter network prior to transmitting the data to the decoder; and transmit the processed data to the decoder.

In one example, the processor 400 is configured to transmit capability information to the receiver node, the capability information comprising an indication of the adapter network. In one example, the capability information is included in a capability report transmitted in an RRC message.

In one example, the processor 400 is configured to activate the adapter network in response to receiving an indication to trigger activation of the adapter network based on the anomaly in the data output by the encoder. In one example, the indication to trigger activation of the adapter network is received in an RRC message or a MAC CE message.

In one example, the anomaly in the data output from the encoder comprises a mismatch between the data output by the encoder and an expected latent space code at the decoder. In one example, the processor 400 is configured to transmit a request for the training data set for the adapter network.

In one example, the training data set comprises a data set comprising latent space codes and channel state information pairs. In one example, the processor 400 is configured to request information for one or more features of the training data set. In one example, the processor 400 is configured to transmit a training data set comprising channel state information and latent space codes pairs to an adapter network at the receiver node.

In one example, the processor 400 is configured to transmit a request to activate the adapter network. In one example, the request to activate the adapter network is transmitted in response to detecting the anomaly in the data output by the encoder at the transmitter node. In one example, the ML model comprises a neural network.

In one example, the processor 400 is configured as part of a receiver node that includes a decoder and an adapter network. In one example, the processor 400 is configured to receive data output by an encoder of a transmitter node, the encoder associated with the decoder; determine an indication of an anomaly in the data output by the encoder; receive a training data set for training the adapter network in response to the indication of the anomaly, the adapter network comprising an ML model that is configured to correct anomalies in the data output by the encoder; train the adapter network using the training data set; process the data output by the encoder using the adapter network; and decode, by the decoder, output from the adapter network.

In one example, the processor 400 is configured to transmit capability information to the transmitter node, the capability information comprising an indication of the adapter network. In one example, the processor 400 is configured to activate the adapter network in response to receiving an indication to trigger activation of the adapter network based on the anomaly in the data output by the encoder.

In one example, the anomaly in the data output by the encoder comprises a mismatch between the data output by the encoder and an expected latent space code at the decoder. In one example, the processor 400 is configured to transmit a request for the training data set for the adapter network.

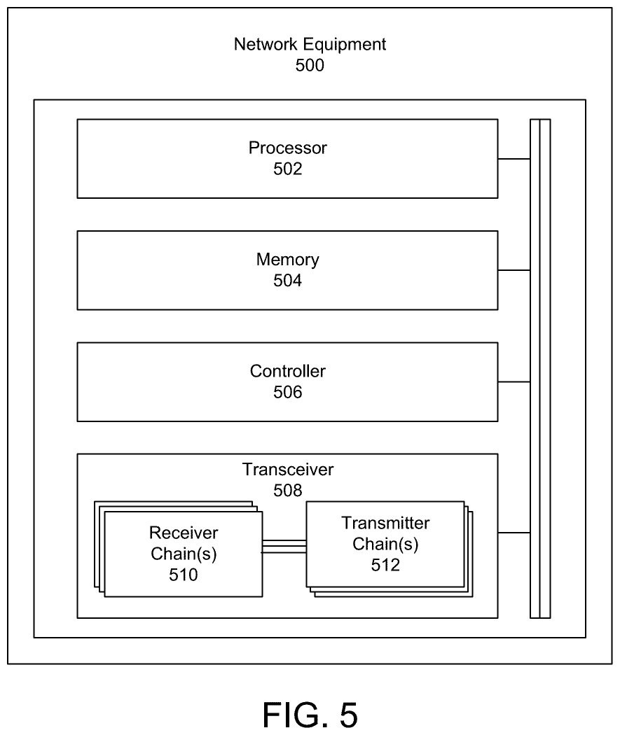

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the RAN functions described herein (e.g., executing, by the processor 502, instructions stored in the memory 504). For example, the processor 502 may support wireless communication at the NE 500 in accordance with examples as disclosed herein.

In one example, the NE 500 is configured as a transmitter node that is configured with an encoder and an adapter network. In one example, the transmitter node is configured to receive an indication of an anomaly in data output by the encoder, the encoder associated with a decoder at a receiver node; receive a training data set for training the adapter network in response to the indication of the anomaly, the adapter network comprising an ML model that is configured to correct anomalies in the data output by the encoder; train the adapter network using the training data set; process the data output from the encoder using the adapter network prior to transmitting the data to the decoder; and transmit the processed data to the decoder.

In one example, the transmitter node is configured to transmit capability information to the receiver node, the capability information comprising an indication of the adapter network. In one example, the capability information is included in a capability report transmitted in an RRC message.

In one example, the transmitter node is configured to activate the adapter network in response to receiving an indication to trigger activation of the adapter network based on the anomaly in the data output by the encoder. In one example, the indication to trigger activation of the adapter network is received in an RRC message or a MAC CE message.

In one example, the anomaly in the data output from the encoder comprises a mismatch between the data output by the encoder and an expected latent space code at the decoder. In one example, the transmitter node is configured to transmit a request for the training data set for the adapter network.

In one example, the training data set comprises a data set comprising latent space codes and channel state information pairs. In one example, the transmitter node is configured to request information for one or more features of the training data set. In one example, the transmitter node is configured to transmit a training data set comprising channel state information and latent space codes pairs to an adapter network at the receiver node.

In one example, the transmitter node is configured to transmit a request to activate the adapter network. In one example, the request to activate the adapter network is transmitted in response to detecting the anomaly in the data output by the encoder at the transmitter node. In one example, the ML model comprises a neural network.

In one example, the NE 500 is configured as a receiver node that includes a decoder and an adapter network. In one example, the receiver node is configured to receive data output by an encoder of a transmitter node, the encoder associated with the decoder; determine an indication of an anomaly in the data output by the encoder; receive a training data set for training the adapter network in response to the indication of the anomaly, the adapter network comprising an ML model that is configured to correct anomalies in the data output by the encoder; train the adapter network using the training data set; process the data output by the encoder using the adapter network; and decode, by the decoder, output from the adapter network.

In one example, the receiver node is configured to transmit capability information to the transmitter node, the capability information comprising an indication of the adapter network. In one example, the receiver node is configured to activate the adapter network in response to receiving an indication to trigger activation of the adapter network based on the anomaly in the data output by the encoder.

In one example, the anomaly in the data output by the encoder comprises a mismatch between the data output by the encoder and an expected latent space code at the decoder. In one example, the receiver node is configured to transmit a request for the training data set for the adapter network.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

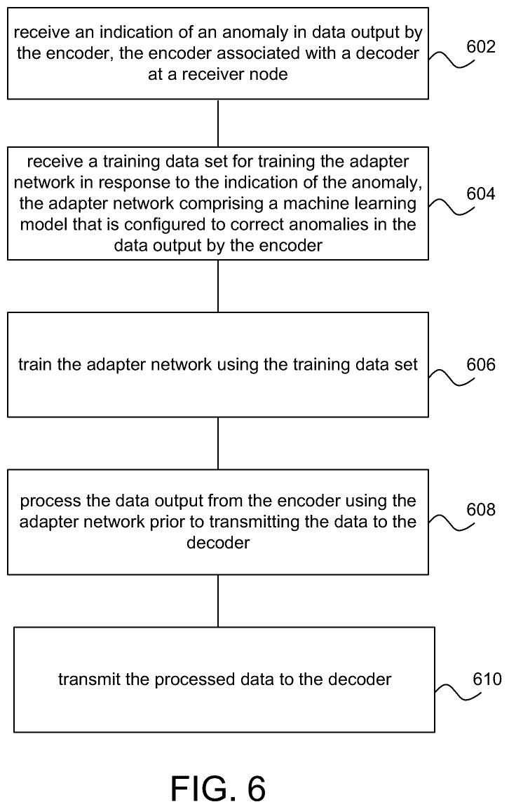

FIG. 6 illustrates a flowchart of a method performed by a transmitter node, e.g., a UE 300 or an NE 500 in accordance with aspects of the present disclosure. The operations of the method may be implemented by a UE 300 or an NE 500 as described herein. In some implementations, the UE 300 or the NE 500 may execute a set of instructions to control the function elements of the UE 300 or the NE 500 to perform the described functions.

At step 602, the method may receive an indication of an anomaly in data output by the encoder, the encoder associated with a decoder at a receiver node. The operations of step 602 may be performed in accordance with examples as described herein. In some implementations, aspects of the operations of step 602 may be performed by a UE 300, as described with reference to FIG. 3, or an NE 500, as described with reference to FIG. 5.

At step 604, the method may receive a training data set for training the adapter network in response to the indication of the anomaly, the adapter network comprising an ML model that is configured to correct anomalies in the data output by the encoder. The operations of step 604 may be performed in accordance with examples as described herein. In some implementations, aspects of the operations of step 604 may be performed by a UE 300, as described with reference to FIG. 3, or an NE 500, as described with reference to FIG. 5.

At step 606, the method may train the adapter network using the training data set. The operations of step 606 may be performed in accordance with examples as described herein. In some implementations, aspects of the operations of step 606 may be performed by a UE 300, as described with reference to FIG. 3, or an NE 500, as described with reference to FIG. 5.

At step 608, the method may process the data output from the encoder using the adapter network prior to transmitting the data to the decoder. The operations of step 608 may be performed in accordance with examples as described herein. In some implementations, aspects of the operations of step 608 may be performed by a UE 300, as described with reference to FIG. 3, or an NE 500, as described with reference to FIG. 5.

At step 610, the method may transmit the processed data to the decoder. The operations of step 610 may be performed in accordance with examples as described herein. In some implementations, aspects of the operations of step 610 may be performed by a UE 300, as described with reference to FIG. 3, or an NE 500, as described with reference to FIG. 5.

It should be noted that the method described herein describes one possible implementation, and that the operations and the steps may be rearranged or otherwise modified and that other implementations are possible.

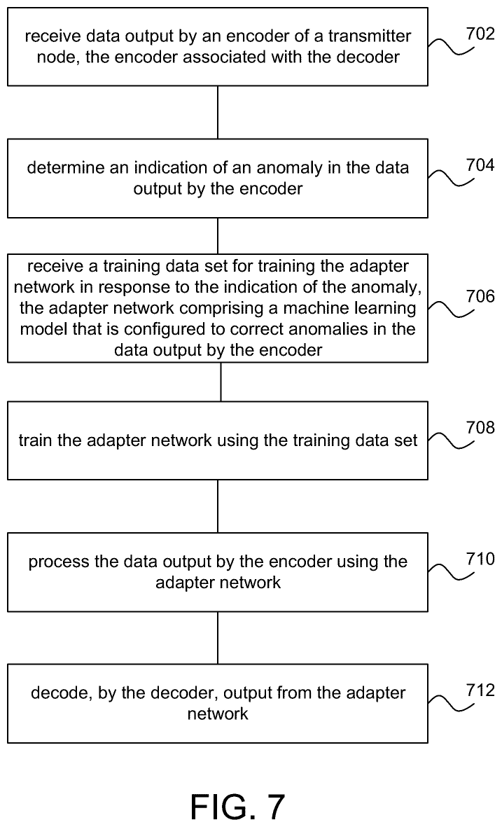

FIG. 7 illustrates a flowchart of a method performed by a receiver node, e.g., a UE 300 or an NE 500 in accordance with aspects of the present disclosure. The operations of the method may be implemented by a UE 300 or an NE 500 as described herein. In some implementations, the UE 300 or the NE 500 may execute a set of instructions to control the function elements of the UE 300 or the NE 500 to perform the described functions.

At step 702, the method may receive data output by an encoder of a transmitter node, the encoder associated with the decoder. The operations of step 702 may be performed in accordance with examples as described herein. In some implementations, aspects of the operations of step 702 may be performed by a UE 300, as described with reference to FIG. 3, or an NE 500, as described with reference to FIG. 5.

At step 704, the method may determine an indication of an anomaly in the data output by the encoder. The operations of step 704 may be performed in accordance with examples as described herein. In some implementations, aspects of the operations of step 704 may be performed by a UE 300, as described with reference to FIG. 3, or an NE 500, as described with reference to FIG. 5.

At step 706, the method may receive a training data set for training the adapter network in response to the indication of the anomaly, the adapter network comprising an ML model that is configured to correct anomalies in the data output by the encoder. The operations of step 706 may be performed in accordance with examples as described herein. In some implementations, aspects of the operations of step 706 may be performed by a UE 300, as described with reference to FIG. 3, or an NE 500, as described with reference to FIG. 5.

At step 708, the method may train the adapter network using the training data set. The operations of step 708 may be performed in accordance with examples as described herein. In some implementations, aspects of the operations of step 708 may be performed by a UE 300, as described with reference to FIG. 3, or an NE 500, as described with reference to FIG. 5.

At step 710, the method may process the data output by the encoder using the adapter network. The operations of step 710 may be performed in accordance with examples as described herein. In some implementations, aspects of the operations of step 710 may be performed by a UE 300, as described with reference to FIG. 3, or an NE 500, as described with reference to FIG. 5.

At step 712, the method may decode, by the decoder, output from the adapter network. The operations of step 712 may be performed in accordance with examples as described herein. In some implementations, aspects of the operations of step 712 may be performed by a UE 300, as described with reference to FIG. 3, or an NE 500, as described with reference to FIG. 5.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A transmitter node for wireless communication, comprising:
an encoder;
an adapter network communicatively coupled to the encoder;
at least one memory; and
at least one processor coupled with the at least one memory and configured to cause the transmitter node to:
receive an indication of an anomaly in data output by the encoder, the encoder associated with a decoder at a receiver node;
receive a training data set for training the adapter network in response to the indication of the anomaly, the adapter network comprising a machine learning model that is configured to correct anomalies in the data output by the encoder;
train the adapter network using the training data set;
process the data output from the encoder using the adapter network prior to transmitting the data to the decoder; and
transmit the processed data to the decoder.

2. The transmitter node of claim 1, wherein the at least one processor is configured to cause the transmitter node to transmit capability information to the receiver node, the capability information comprising an indication of the adapter network.

3. The transmitter node of claim 2, wherein the capability information is included in a capability report transmitted in a radio resource control message.

4. The transmitter node of claim 1, wherein the at least one processor is configured to cause the transmitter node to activate the adapter network in response to receiving an indication to trigger activation of the adapter network based on the anomaly in the data output by the encoder.

5. The transmitter node of claim 4, wherein the indication to trigger activation of the adapter network is received in a radio resource control message or a medium access control control element message.

6. The transmitter node of claim 1, wherein the anomaly in the data output by the encoder comprises a mismatch between the data output by the encoder and an expected latent space code at the decoder.

7. The transmitter node of claim 1, wherein the at least one processor is configured to cause the transmitter node to transmit a request for the training data set for the adapter network.

8. The transmitter node of claim 1, wherein the training data set comprises a data set comprising latent space codes and channel state information pairs.

9. The transmitter node of claim 1, wherein the at least one processor is configured to cause the transmitter node to request information for one or more features of the training data set.

10. The transmitter node of claim 1, wherein the at least one processor is configured to cause the transmitter node to transmit a training data set comprising channel state information—latent space codes pairs to an adapter network at the receiver node.

11. The transmitter node of claim 1, wherein the at least one processor is configured to cause the transmitter node to transmit a request to activate the adapter network.

12. The transmitter node of claim 11, wherein the request to activate the adapter network is transmitted in response to detecting the anomaly in the data output by the encoder at the transmitter node.

13. The transmitter node of claim 11, wherein the machine learning model comprises a neural network.

14. A method of a transmitter node, comprising:
receiving an indication of an anomaly in data output by an encoder, the encoder associated with a decoder at a receiver node;
receiving a training data set for training an adapter network in response to the indication of the anomaly, the adapter network comprising a machine learning model that is communicatively coupled to the encoder and is configured to correct anomalies in the data output by the encoder;
training the adapter network using the training data set;
processing the data output from the encoder using the adapter network prior to transmitting the data to the decoder; and
transmitting the processed data to the decoder.

15. A receiver node for wireless communication, comprising:
a decoder;
an adapter network communicatively coupled to the decoder;
at least one memory; and
at least one processor coupled with the at least one memory and configured to cause the receiver node to:
receive data output by an encoder of a transmitter node, the encoder associated with the decoder;
determine an indication of an anomaly in the data output by the encoder;
receive a training data set for training the adapter network in response to the indication of the anomaly, the adapter network comprising a machine learning model that is configured to correct anomalies in the data output by the encoder;
train the adapter network using the training data set;
process the data output by the encoder using the adapter network; and
decode, by the decoder, output from the adapter network.

16. The receiver node of claim 15, wherein the at least one processor is configured to cause the receiver node to transmit capability information to the transmitter node, the capability information comprising an indication of the adapter network.

17. The receiver node of claim 15, wherein the at least one processor is configured to cause the receiver node to activate the adapter network in response to receiving an indication to trigger activation of the adapter network based on the anomaly in the data output by the encoder.

18. The receiver node of claim 15, wherein the anomaly in the data output from the encoder comprises a mismatch between the data output by the encoder and an expected latent space code at the decoder.

19. The receiver node of claim 15, wherein the at least one processor is configured to cause the receiver node to transmit a request for the training data set for the adapter network.

20. A method of a receiver node, comprising:
receiving data output by an encoder of a transmitter node, the encoder associated with a decoder of the receiver node;
determine an indication of an anomaly in the data output by the encoder;
receive a training data set for training an adapter network in response to the indication of the anomaly, the adapter network comprising a machine learning model that is configured to correct anomalies in the data output by the encoder;
train the adapter network using the training data set;
process the data output by the encoder using the adapter network; and
decode, by the decoder, output from the adapter network.
